(19) United States
(12) Patent Application Publication
(10) Pub. No.: US 2024/0039083 A1
(43) Pub. Date: Feb. 1, 2024

(54) Electrical Energy Store for a Motor Vehicle and Motor Vehicle

(71) Applicant: Bayerische Motoren Werke Aktiengesellschaft, Muenchen (DE)

(72) Inventor: Attila FARKAS, Muenchen (DE)

(21) Appl. No.: 18/226,104

(22) Filed: Jul. 25, 2023

(30) Foreign Application Priority Data
Jul. 26, 2022 (DE) 10 2022 118 629.6

(51) Int. Cl. H01M 10/6568; H01M 50/213; H01M 10/6556; H01M 10/625; H01M 10/643; H01M 50/107; H01M 10/615; H01M 10/657; B60L 50/64

(52) U.S. Cl. CPC H01M 10/6568; H01M 50/213; H01M 10/6556; H01M 10/625; H01M 10/643; H01M 50/107; H01M 10/615; H01M 10/657; B60L 50/64; H01M 2220/20

(57) ABSTRACT

An electrical energy store for storing electrical energy for a motor vehicle, having a plurality of storage cells which are configured to store the electrical energy and which each have a cell housing which delimits a receiving space, and a line element through which a temperature-control liquid can flow and which extends through the receiving space, wherein the storage cells are retained with a cell holder which is constructed separately from the storage cells and which at least limits relative movements between the storage cells, and which has domes through which the temperature-control liquid can flow and which are inserted into the line elements, and via which the temperature-control liquid can be introduced into the line elements and/or discharged from the line elements.

### CROSS REFERENCE TO RELATED APPLICATION

This application claims priority under 35 U.S.C. § 119 from German Patent Application No. 102022118629.6, filed Jul. 26, 2022, the entire disclosure of which is herein expressly incorporated by reference.

### BACKGROUND AND SUMMARY

The invention relates to an electrical energy store for a motor vehicle according to the present disclosure. The invention further relates to a motor vehicle having at least one such energy store.

DE 10 2016 009 910 A1 discloses a battery apparatus having a tubular housing which surrounds a battery cell space. In the battery cell space at least one battery cell or at least one battery cell winding is received or can at least be received. The housing has an outer cover and axially opposed end faces on which at least one electrical contact is arranged in each case. In this instance, a cooling line is guided through the battery cell space and through housing faces.

WO 2019/043413 A1 discloses a modular carrier element for cylindrical battery cells.

DE 10 2008 009 041 A1 further discloses a drive battery sub-assembly of an electrical fuel cell or hybrid vehicle for transporting people and/or goods.

An object of the present invention is to provide an electrical energy store for a motor vehicle and a motor vehicle having at least one such electrical energy store so that a particularly advantageous temperature control can be carried out in a particularly cost-effective manner.

This object is achieved according to the invention with an electrical energy store having the features as disclosed herein and by a motor vehicle having the features as disclosed herein. The present disclosure also relates to advantageous embodiments of the invention.

A first aspect of the invention relates to an electrical energy store which is also simply described as a store for in particular electrochemical storage of electrical energy or electrical current for a motor vehicle. Preferably, the electrical energy store is in the form of a battery, in particular a secondary battery, so that by means of the electrical energy store the electrical energy is intended to be stored or is stored, in particular electrochemically. The motor vehicle which is preferably in the form of a motor car, in particular a passenger vehicle, consequently has in the completely produced state thereof the electrical energy store. Preferably, the electrical energy store is in the form of a high-voltage component, the electrical voltage of which, in particular electrical operating or nominal voltage, is preferably greater than 50 Volt (V), in particular greater than 60 Volt, and very preferably several hundred volt. It is thereby possible, for example, to produce particularly large electrical powers for in particular purely electrical driving of the motor vehicle. Preferably the motor vehicle is in the form of a hybrid or electric vehicle, in particular a battery electric vehicle (BEV). Consequently, the motor vehicle has in the completely produced state thereof, for example, at least one electrical machine by means of which the motor vehicle can be driven in particular in a purely electric manner. To this end, the electric machine is supplied with the electrical energy stored in the electrical energy store. Preferably, the electric machine is a high-voltage component, the electrical voltage of which in particular electrical operating or nominal voltage, is preferably greater than 50 V, in particular greater than 60 V and very preferably several hundred volts.

The electrical energy store which is also simply referred to as an energy store has a plurality of storage cells in or by means of which the electrical energy is intended to be stored or is stored in particular electrochemically. The storage cells are also referred to as cells and are individual cells, consequently structural elements which are formed separately from each other. In particular, the respective storage cell is a battery cell, consequently a secondary cell. Again, in other words, there is preferably provision for the respective storage cell to be in the form of an accumulator or an accumulator cell.

The respective storage cell has a cell housing by means of which a receiving space of the respective storage cell is delimited, in particular directly. For example, a respective storage device for in particular electrochemical storage of the electrical energy is arranged in the respective receiving space of the respective storage cell. The storage device comprises, for example, at least one electrode. In particular, the respective storage device preferably comprises at least or precisely two electrodes. For example, a first of the electrodes has a first electrical polarity, wherein, for example, the respective second electrode has a second electrical polarity which is different from the first electrical polarity. Consequently, for example, one of the electrodes is in the form of a cathode and the other electrode is in the form of an anode. Alternatively or additionally, the respective storage device may have a respective, in particular liquid, electrolyte, wherein, for example, the electrode is in particular in direct contact with the electrolyte.

The respective storage cell also has a respective line element through which a preferably liquid temperature-control means for temperature control can flow, that is to say, in order to cool and/or heat the respective storage cell. The respective line element passes or extends through the respective receiving space, in particular in such a manner that the respective line element per se, that is to say, when considered in isolation, opens at both ends thereof, that is to say, at the two ends, in a respective environment of the respective storage cell or the respective cell housing. In particular, it is conceivable for the respective line element to pass or extend through the respective storage device.

For example, the respective storage cell, in particular the respective cell housing, has two end sides or end faces, wherein the end sides or the end faces are spaced apart from each other in a spacing direction and are opposite each other. It is conceivable for the respective line element to be constructed separately from the respective cell housing and to be connected to the respective cell housing. Furthermore, for example, it is conceivable for the respective cell housing to have a respective housing cover which extends, in particular in the spacing direction, for example, between the end sides or end faces. In particular, it is conceivable for the end faces or end sides and the housing cover to delimit the respective receiving space, in particular directly. It is conceivable for the storage cell to be a cylindrical storage cell and consequently to be constructed at the outer circumferential side in a cylindrical or round or circular manner so that, for example, the respective housing cover which is also referred to as a cell cover is also constructed at the outer circumference in a cylindrical or round or circular manner so that, for example, the cell cover is constructed at the outer circumference in a cylindrical or round manner, in particular in a circular manner. However, the respective storage cell may have any form at the outer circumferential side so that the respective storage cell may, for example, be constructed in a prismatic manner at the outer circumferential side. In particular, it is conceivable for the spacing direction of the respective storage cell to coincide with a respective elongate extent direction of the respective storage cell which can extend in an elongate manner in the longitudinal extent direction thereof. In this instance, it is particularly conceivable for the line element to extend through the end sides or the end faces. Consequently, for example, the temperature-control means can be introduced into the line element from outside the respective storage cell, in particular via a first one of the ends of the line element, and, for example, the temperature-control means can be discharged out of the line element, in particular after it has flowed through the respective line element, in particular via the second end of the respective line element, and consequently can be guided to the environment of the respective storage cell per se.

In order to be able to carry out a particularly advantageous temperature control, that is to say, cooling and/or heating, of the storage cell in a particularly advantageous manner, there is provision according to the invention for the electrical energy store to have a cell holder which is constructed separately from the storage cells and consequently separately from the cell housings and the line elements and which is also simply referred to as a holder and in which the storage cells are in particular directly retained, whereby relative movements between the storage cells are at least limited, in particular prevented. This means that the cell holder at least limits, in particular prevents, relative movements between the storage cells. In particular, the storage cells are retained on each other by means of the cell holder or held together. This is intended in particular to be understood to mean that the storage cells are retained relative to each other by means of the cell holder in a pattern which is predetermined by the cell holder. Furthermore, there is in a particularly preferred manner provision for the storage cells to be held by means of the cell holder, in particular in pairs, with a respective spacing with respect to each other so that there is preferably provision for the storage cells not to touch each other directly.

The cell holder has domes through which preferably liquid temperature-control means can flow and which are inserted into the line elements, in particular via the respective ends of the respective line elements and via which the temperature-control means can be introduced into the line elements and/or can be discharged from the line elements, that is to say, can be directed out of the line elements. The domes are, for example, in particular elongate projections which are inserted into the line elements and consequently are in each case at least partially arranged in the line elements. A simple, cost-effective and effective and efficient supply of the line elements with the temperature-control means can thereby be produced and the temperature-control means can be discharged via the domes in a simple, cost-effective, effective and efficient manner from or out of the line elements. The electrical energy store can be produced in a particularly simple and consequently time-saving and cost-effective manner. To this end, for example, the domes are simply inserted into the line elements, whereby an effective and efficient supply and/or discharge of the temperature-control means to or from the line elements can be produced. Since the temperature-control means on its path through the domes and the line elements is guided by means of the line elements through the receiving spaces and consequently flows through the receiving spaces of the storage cells, a particularly effective and efficient temperature-control, that is to say, cooling and/or heating, of the storage cells can be achieved. In particular, a temperature control of the storage cells in the manner of an immersion temperature control can be produced, but without an actual immersion temperature control having to be produced and consequently having to accept disadvantages of such an immersion temperature control. An immersion temperature control is in particular intended to be understood to mean that, for example, during operation of the electrical energy store, the storage cells, in particular at the outer circumferential side, are directly in contact with the temperature-control means and are flowed toward and around by the temperature-control means. However, it has been found that such an immersion temperature control can have such a disadvantage that undesirable leakages and/or corrosion effects can arise. Such an immersion temperature control can, however, control the temperature of the storage cells in an effective and efficient manner since a particularly advantageous, effective and efficient heat exchange between the temperature-control means and the storage cells can be ensured. As a result of the invention, it is possible with an immersion temperature control to prevent any undesirable effects such as undesirable leakages and corrosion effects which may occur and nonetheless to produce an effective and efficient temperature control of the storage cells since, as a result of the fact that the temperature-control means is guided through the receiving spaces by means of the line elements, an effective and efficient heat exchange can be carried out between the storage cells and the temperature-control means. If, for example, the temperature-control means has a higher temperature than the storage cells, whilst the temperature-control means flows through the line elements and consequently the receiving spaces, there is, for example, a heat transfer from the temperature-control means via the line elements to the storage cells, whereby the storage cells are heated and/or kept warm. If, for example, the temperature-control means has a lower temperature than the storage cells, whilst the temperature-control means flows through the line elements and consequently through the receiving spaces, heat can thus transfer via the line elements from the storage cells to the temperature-control means, whereby the storage cells are cooled.

Furthermore, as a result of the invention a function integration can be achieved, whereby the costs can be kept particularly low. In particular, the respective line element may have a plurality of functions. A first of the functions may be a support function, in the context of which, for example, the line element supports the respective storage device of the respective storage cell and consequently, for example, protects it from undesirable collapsing, in particular as a result of charging and discharging operations. A second of the functions may comprise a housing function, in the context of which the line element delimits the receiving space partially, for example, directly. A third of the functions may be a line function, in the context of which by means of the line element the temperature-control means is selectively and advantageously guided or directed, in particular through the receiving space, whereby an effective and efficient temperature control of the storage cells can be achieved.

It is conceivable, for example, on a first of the end sides and/or on a second of the end sides for at least one or precisely one connection element which is also referred to as a terminal to be able to be provided. For example, the storage cells are electrically connected to each other by means of the connection elements and are in this instance connected, for example, in series or in parallel with each other. For example, the respective storage cell may provide via the respective connection elements thereof the electrical energy which is stored in the respective storage cell. Furthermore, it is conceivable, via the connection elements of the respective storage cell, for electrical energy to be able to be fed into the respective storage cell in order to consequently store the electrical energy in the respective storage cell. With the invention, a particularly advantageous temperature control of the connection elements can also be achieved.

The domes are also referred to as male pieces since they are inserted into the line elements which are in the form of female pieces or also referred to as female pieces. The invention enables the domes not to have to be constructed in accordance with an SAE standard as is the case, for example, with rapid-fit couplings which are also referred to as quick connectors (QC). Consequently, a costly retention collar can be prevented. Such retention collars or other costly elements which, for example, prevent the domes from being pushed out of the line elements by means of a corresponding pressure of the temperature-control means, can be avoided since the domes are components of the cell holder. The cell holder is also referred to as a cell carrier or as a carrier.

The line element is so to speak a respective female piece of a rapid-fit connection. This is intended in particular intended to be understood to mean that the respective dome can be connected in a particularly rapid and consequently cost-effective manner at least fluidically and preferably also mechanically to the respective line element, in particular as a result of the fact that the respective dome is inserted into the respective line element in particular in the spacing direction or in the longitudinal extent direction of the respective storage cell. The respective fluid connection of the respective dome and the respective line element is intended in particular to be understood to mean that the temperature-control means can flow through the respective dome and through the respective line element and can consequently flow, for example, from the respective dome into the respective line element or from the respective line element into the respective dome. In particular, the invention enables the number of components and consequently the construction spatial requirement and the costs of the electrical energy store to be able to be kept particularly low. In particular, for example, the invention enables the electrical energy store to be produced from only seven individual elements, of which, for example, only six are components which are different from each other.

In order to be able to produce a particularly effective and efficient temperature control and to prevent undesirable leakages in a particularly simple manner, in another embodiment of the invention, there is provision for the respective dome to be sealed with respect to the respective line element in which the respective dome is inserted by means of at least one respective sealing element which is constructed separately from the respective line element and separately from the respective dome. For example, the respective sealing element is made from a rubber. Furthermore, it is conceivable for the respective sealing element to be in the form of a respective sealing ring, in particular an O-ring. In this instance, it has been found to be particularly advantageous for at least first of the sealing elements to be arranged in corresponding indentations of the respective cell housing. Undesirable relative movements between the first sealing elements and the domes and the first sealing elements and the cell housings can thereby be prevented so that an effective and efficient sealing can be achieved in a simple manner. In particular, it is conceivable for in particular each dome for at least one sealing element which is in the form of an O-ring to be inserted, that is to say, used, in particular in order to seal the respective dome with respect to the line element. In particular for each dome, at least or precisely two sealing elements which are in the form of O-rings can particularly be used, in particular in order to seal the respective dome against the respective line element. In this instance, it is conceivable for the sealing elements to be formed from different materials, in particular in order to cover negative and high positive temperature ranges. Consequently, for example, for each storage cell at least or precisely four sealing elements are provided since, for example, for each storage cell at least or precisely two domes which are sealed by means of the at least or precisely two sealing elements with respect to the respective line element are provided.

Another embodiment is characterized in that, as a result of the respective indentation, at least one respective structural element, which is constructed separately from the respective cell housing and which is formed in the respective receiving space, of the respective storage cell is fixed to the respective cell housing. Preferably, there is provision as a result of the respective indentation for a plurality of respective structural elements, which are constructed separately from the respective cell housing and separately from each other and which are arranged in the receiving space, of the respective storage cell to be fixed to the respective cell housing and fixed to each other. Consequently, the indentation has a dual function. On the one hand, the indentation is used in order to fix the at least one structural element on the respective cell housing. On the other hand, the indentation is used to fix the sealing element. Undesirable leakages can thereby be prevented in a simple and cost-effective manner, whereby a particularly effective and efficient temperature control can be achieved.

For example, the respective indentation is produced by means of crimping. Consequently, for example, the at least one respective structural element is fixed to the respective cell housing by means of crimping.

In another, particularly advantageous embodiment of the invention, the respective structural elements comprises a respective contact element and/or a respective electrical heating element. The background to this embodiment is that structural elements, such as electrical contact elements and electrical heating elements, are in any case intended to be fixed to the respective cell housing in order to be able to ensure a desired function of the respective storage cell. The invention now uses a fixing step which is in any case used and by means of which the at least one structural element is fixed to the respective cell housing in order to also fix the sealing element and consequently to be able to produce an effective and efficient temperature control in a particularly cost-effective manner.

In a particularly advantageous embodiment of the invention, first ones of the domes are in the form of supply domes, via which the temperature-control means can be introduced into the line elements. The supply domes are in this instance inserted from a first side into the line elements, consequently protrude from the first side into the line elements, in particular from the environment of the respective storage cell. Second ones of the domes are in the form of discharge domes, via which the temperature-control means can be discharged from the line elements, consequently can be directed out of the line elements. The second domes are inserted from a second side into the line elements and consequently discharge, for example, from the second side into the line elements, in particular from the environment of the respective storage cell. In this instance, the second side is opposite the first side or vice versa, in particular in the spacing or longitudinal extent direction. In particular, the or all the supply domes are arranged at the same first side. Alternatively or additionally, it is conceivable for the or all the discharge domes to be arranged at the same, second side. An effective and efficient temperature control of the storage cells can thereby be ensured.

In order to be able to keep costs within a particularly low range, in an additional embodiment of the invention there is provision for the supply domes to be constructed integrally with each other. This is intended to be understood to mean that the supply domes which are also described as supplying domes or feeding domes are formed from a single piece, that is to say, are formed by a single piece. Again, in other words, the supply domes are formed from a monobloc or by a monobloc.

In order to be able to produce a particularly effective and efficient temperature control in a particularly cost-effective manner, in another embodiment of the invention there is provision for the electrical energy store to have a supply line element which is common to one or all supply domes and through which a temperature-control means can flow and via which the supply domes can be supplied with the temperature-control means. In this instance, the supply line element is constructed integrally with the supply domes. This means that the supply domes and the supply line element which is common to the supply domes are formed from a single piece, consequently by means of a single piece, so that the supply domes and the supply line elements are formed from a monobloc or by a monobloc. This means that the supply domes and the supply line element are not made from and consequently formed from components which are constructed separately from each other and connected to each other but instead the supply domes and the supply line elements are formed from a single piece, consequently formed by means of an integral member, which is formed from a single piece.

In order to be able to keep the costs in a particularly low range, in another embodiment of the invention there is provision for the discharge domes to be constructed integrally with each other. This is intended to be understood to mean that the discharge domes are preferably not formed and consequently composed of components which are constructed separately from each other and connected to each other but instead the discharge domes are preferably formed from a single piece and consequently formed from or by a monobloc.

In order to be able to achieve a particularly effective and efficient temperature control in a particularly cost-effective manner, in another embodiment of the invention there is provision for the electrical energy store to have a discharge line element which is common to the discharge domes and which is constructed integrally with the discharge domes and through which temperature-control means can flow and in which the temperature-control means can be introduced from the discharge domes so that via the discharge line element the temperature-control means can be discharged from the discharge domes, that is to say, can be directed out of the discharge domes. This means that the discharge domes and the discharge line element are not formed as components which are constructed separately from each other and connected to each other, but instead the discharge domes and the discharge line element are preferably formed from a single piece, consequently formed by or from a monobloc so that the discharge domes and the discharge line element are preferably formed by means of a member which is constructed in an integral manner and which is formed from a single piece and consequently in the form of a monobloc. In principle, it would be conceivable for the previously mentioned members, consequently the member which is also described as the first member and by means of which the supply domes and the supply line element are formed, and the member which is also referred to as the second member and by means of which the discharge domes and the discharge line element are formed, to be constructed integrally with each other. Quite preferably, there is also provision for the first member and the second member to be constructed separately from each other and connected to each other, wherein the first member is formed from a single piece and the second member is formed from a single piece.

Another embodiment is characterized in that the cell holder has a first holder portion which has the supply domes and which is arranged at the first side and which, for example, is the first member or is formed by the first member. The cell holder further has a second holder portion which has the discharge domes and which is arranged on the second side and which, for example, is the second member or is formed by the second member. The holder portions are constructed separately from each other and connected to each other. Preferably, consequently, the first holder portion is constructed in an integral manner, consequently formed from a single piece, so that the first holder portion is a first monobloc or is formed by a first monobloc. Alternatively or additionally, there is preferably provision for the second holder portion to be constructed in an integral manner and consequently formed from a single piece so that the second holder portion is a second monobloc or is formed by a second monobloc. The costs can thereby be kept particularly low.

In another particularly advantageous embodiment of the invention, the first holder portion has a first covering element which is arranged at the first side and of which, in a first direction which faces from the first side and from the first covering element to the second side, the supply domes and first column portions of the first holder portion protrude. Consequently, there is preferably provision for the first column portions also to be formed by the first member so that the first column portions and the supply domes are preferably constructed integrally with each other. The second holder portion has a second covering element which is arranged on the second side and from which in a second direction which is counter to the first direction and which faces from the second side and from the second covering element to the first side the discharge domes and second column portions of the second holder portion protrude. Preferably, there is provision for the second member to form the second column portions so that the second column portions can be illustrated integrally with the discharge domes. On the whole, it can be seen that, for example, the first covering element, the first column portions and the supply domes and preferably also the supply line element are constructed integrally with each other, that is to say, are formed from a single piece. Furthermore, there is preferably provision for the second covering element, the second column portions and the discharge domes and preferably also the discharge line element to be constructed integrally with each other, that is to say, formed from a single piece.

A respective one of the first column portions and a respective one of the second column portions form a respective column portion pair, the respective second column portion of which adjoins in the first direction the first column portion of the respective column portion pair. In this instance, the respective column portions of the respective column pair are connected to each other, whereby the holder portions are connected to each other. A particularly simple and consequently cost-effective production of the electrical energy store can thereby be produced. In order to produce the electrical energy store, for example, the supply domes and the discharge domes are inserted into the line elements in particular in such a manner that the supply domes are inserted in the first direction and the discharge domes are inserted in the second direction into the line elements. The domes are in particular inserted into the line elements in such a manner that the column portions of the column portion pairs are connected to each other, whereby the holder portions are connected to each other. As a result of the connection of the holder portions, the domes are in particular prevented from being pressed out of the line elements by means of a pressure of the temperature-control means so that a particularly simple and cost-effective construction and a particularly simple and cost-effective production or assembly of the energy store can be produced, wherein at the same time an effective and efficient temperature control of the storage cells can be achieved.

In order to be able to connect the column portions and consequently the holder portions to each other in a simple and cost-effective and particularly secure manner, in another embodiment of the invention there is provision for the respective column portions of the respective column portion pair to be locked to each other, whereby the holder portions are locked to each other.

Finally, it has been found to be particularly advantageous for the respective holder portion to be constructed in an integral manner, consequently formed from a single piece. The number of components and consequently the costs of the electrical energy store can thereby be kept in a particularly low range.

A second aspect of the invention relates to a motor vehicle which is preferably in the form of a motor car, in particular a passenger vehicle, having at least one electrical energy store according to the first aspect of the invention. Advantages and advantageous embodiments of the first aspect of the invention are intended to be considered to be advantages and advantageous embodiments of the second aspect of the invention and vice versa.

Further details of the invention will be appreciated from the following description of a preferred embodiment with the associated drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a cut-out of a schematic exploded view of an electrical energy store for a motor vehicle;

FIG. 2 shows a cut-out of a schematic side view of the electrical energy store;

FIG. 3 shows a cut-out of a schematic and sectioned side view of the electrical energy store;

FIG. 4 shows a cut-out of a schematic side view of the electrical energy store; and

FIG. 5 shows a cut-out of another schematic side view of the electrical energy store.

### DETAILED DESCRIPTION OF THE DRAWINGS

In the Figures, identical or functionally identical elements are given the same reference numerals.

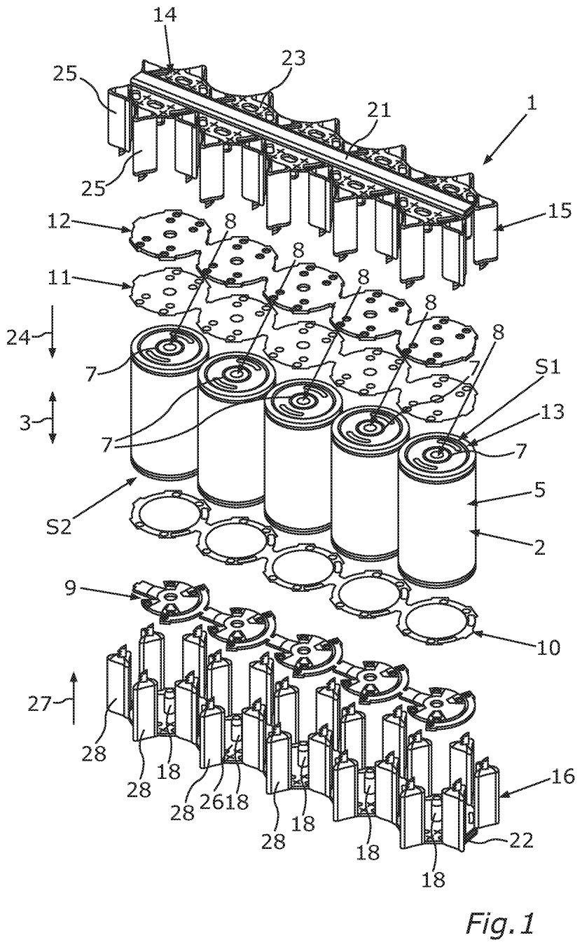

FIG. 1 shows as a schematic exploded view an electrical energy store 1 for a motor vehicle. This means that the motor vehicle which is preferably in the form of a motor car, in particular a passenger vehicle in the completely produced and/or functional state thereof has the electrical energy store 1 which is also simply referred to as a store. In the or by means of the energy store 1, electrical energy or electrical current can be stored in particular in an electrochemical manner so that the electrical energy store 1 is preferably a battery, in particular a secondary battery. In particular, the energy store 1 is a high-voltage battery, that is to say, a high-voltage store (HV store), the electrical current of which, in particular electrical operating or nominal voltage, is preferably greater than 50 Volt, in particular greater than 60 Volt and very preferably several hundred volts. The energy store 1 has a plurality of storage cells 2 which in the embodiment which is shown in the Figures are in the form of round cells and are consequently formed in a cylindrical manner at the outer circumference. However, the preceding and following statements can, of course, also be transferred to other storage cells, which are not formed at the outer circumferential side in a cylindrical, but instead, for example, prismatic manner, or have a different shape. In the or by means of the storage cells 2, the electrical energy can be stored in particular in an electrochemical manner so that the respective storage cell 2 is preferably in the form of a secondary cell. It can be seen that the storage cells 2 are structural elements which are constructed separately from each other and consequently are individual cells. FIG. 1 shows by way of example precisely one cell row with precisely five storage cells, but wherein the energy store 1 can be freely scaled with respect thereto in terms of length and width.

The respective storage cell 2 has a respective longitudinal extent direction which is illustrated in FIG. 1 by a double-headed arrow 3 and consequently a longitudinal extent which extends in the longitudinal extent direction. In this instance, the respective storage cell 2 has a respective first end side S1 and a respective second end side S2, wherein the end sides S1 and S2 of the respective storage cell 2 face away from each other in the longitudinal extent direction of the respective storage cell 2 and are in this instance arranged on respective, in particular free ends of the respective storage cell 2. The respective end side S1, S2 is also referred to as an end face or is formed by a respective end face of the respective storage cell 2. The respective storage cell 2 has in this instance a respective cell housing 4 which has the end sides S1 and S2 or the end faces.

As can be seen together with FIG. 3, the respective cell housing 4 delimits a respective receiving space 5 of the respective storage cell 2, in particular directly. In this instance, for example, in the respective receiving space 5 a respective storage device 6 of the respective storage cell 2 is received, wherein by means of the respective storage device 6 the electrical energy can be stored, in particular in an electrochemical manner. Furthermore, it can be seen particularly clearly from FIG. 3 that the respective storage cell 2 has a respective line element 7, through which a preferably liquid temperature-control means can flow in order to control the temperature of the respective storage cell 2 and which extends through the respective receiving space 5 and the respective end side S1 and S2. The respective line element 7 may be a component of the respective cell housing 4. In this instance, it is conceivable for the respective line element 7 to be constructed separately from at least one of the end sides S1 and S2, in particular separately from both end sides S1 and S2 and to be connected to the at least one end side S1 and S2, in particular to the end sides S1 and S2. The line element 7 is also referred to as a pipe and has a channel 8 through which the temperature-control means can flow and which penetrates or extends through the respective receiving space 5 and in particular the respective end side S1 and S2. As can further be seen in FIG. 3, it is conceivable for the respective line element 7 and consequently the respective channel 8 to penetrate or extend through the respective storage device 6, in particular in the longitudinal extent direction of the respective storage cell 2. Consequently, there is in particular provision for the respective line element 7 to penetrate or extend through the respective receiving space 5 in the respective longitudinal extent direction so that the temperature-control means on its path through the respective channel 8 and consequently the respective line element 7 in the longitudinal extent direction of the respective storage cell 2 flows through the respective line element 7 and consequently through the respective receiving space 5. In this instance, in FIG. 3, the temperature-control means 7 which can flow through the respective line element 7 or the flow direction thereof is illustrated by means of a respective arrow 35. It is clear that channels through which the temperature-control means can flow may be closed at least at one or precisely one respective end of the respective channel in order to produce a guide or direction of the temperature-control means, in particular in accordance with the arrows 35.

For example, the respective storage cell 2 has two electrode connections which are also referred to as connection elements or terminals, wherein, for example, a first of the electrode connections has a first electrical polarity and a second of the electrode connections has a second electrical polarity which is different from the first electrical polarity. The electrode connections are contact regions, which are also referred to as connection regions. The electrical energy store 1 has in this instance a contacting device 9 which is also referred to as a contacting system or cell contacting system and which has electrical contact with or is connected to the contact regions, in particular directly, whereby the contacting device 9 is electrically connected to the storage cells 2 by means of the respective contact regions. The storage cells 2 are thereby electrically connected to each other via the contacting device 9, that is to say, by means of the contacting device 9. For example, the respective first electrode connection forms a respective first electrical pole of the respective storage cell 2. For example, the respective second electrode connection forms a second electrical pole of the respective storage cell 2, wherein the first electrical pole has the first electrical polarity and the second electrical pole has the second electrical polarity which is opposite the first electrical polarity. For example, the first electrical pole is an electrical plus pole so that the first electrode connection is, for example, also referred to as a cathode connection or cathode. For example, the second electrical pole is an electrical minus pole so that the second electrode connection is, for example, also referred to as an anode connection or anode. Consequently, the contacting device 9 is electrically connected to the electrode connections, in particular directly. In the embodiment illustrated in FIG. 1, for example, both the respective first electrode connection and the respective second electrode connection of the respective storage cell 2 is arranged at the same end side S2 of the respective storage cell 2. Consequently, for example, the contacting device 9 is electrically connected to the first electrode connections and to the second electrode connections at respective end sides S2, in particular directly. For example, the contacting device 9 has at least a first contacting element which is electrically connected to the respective first electrode connections, in particular in each case directly. Furthermore, it is conceivable for the contacting device 9 to have, for example, a second contacting element which may preferably be galvanically separated from the first contacting element or electrically insulated from the first contacting element. For example, the second contacting element is in particular directly electrically connected to the respective second electrode connections. Via the contacting device 9, the storage cells 2 may be connected to each other in series or, however, in parallel. Via the electrode connections, the storage cells 2 may provide the electrical energy which is stored in the storage cells 2. Furthermore, the storage cells 2 can be supplied by means of the electrode connections thereof with electrical energy which can thereby be stored in the storage cells 2.

The contacting device 9 which is also referred to as an electrical contacting is shown in FIG. 1 in a particularly schematic and exemplary manner, can also be freely changed or expanded, in particular for a series or parallel connection.

There is, for example, also provided an insulation device 19 which may, for example, be in the form of an insulation film or insulation coating. The electrically insulating insulation device 10 changes a short circuit between the respective anode and the respective cathode of the respective storage cell 2, wherein, for example, the contacting device 9 is provided, in particular coated, with the electrically insulating insulation device 10. Accordingly, for example, the insulation device 10 can be freely changed or expanded, in particular in order to be able to produce a corresponding parallel or series connection of the storage cells 2. It can be seen that the insulation device 10 is arranged at the respective end side S2 and in particular between the respective end side S2 and the contacting device 9. On or at the respective end side S1, for example, another insulation device 11 is arranged. The insulation device 11 is electrically insulating and, for example, in the form of an insulating film. In the embodiment shown in FIG. 1, an in particular thermally conductive filling plate 12 is provided, wherein, for example, the insulation device 11 is arranged between the respective end side S1 and the filling plate 12. The filing plate 12 is in particular used, for example, to produce a symmetrical structure both on the end sides S1 and on the end sides S2. Since, for example, on the end sides S1 no contacting device is used to electrically connect the storage cells 2, the filling plate 12 which in particular when viewed in the longitudinal extent direction of the respective storage cell 2 has the same height or thickness as the contacting device 9 and consequently so to speak represents a place holder for the contacting device 9 is used.

The respective storage cell 2, in particular the respective cell housing 4, further has, for example, a ventilation device 13. The respective ventilation device 13 has, for example, a respective desired failure location, in particular a desired breaking location, on which, for example, when a pressure applied in the receiving space 5 exceeds a particularly predeterminable or predetermined threshold value, fails, and releases a discharge opening of the respective cell housing 4 so that, for example, a gas can be discharged from the respective cell housing 4 via the released outlet opening, in particular without the respective storage cell 2 bursting in an uncontrolled manner. The respective discharge opening is also referred to simply as an opening or ventilation hole or ventilation opening. A respective orientation of the respective outlet opening is, for example, selected in such a manner that a discharge of the hot gas during a thermal event does not cause a temperature control channel to melt. In addition or instead of the outlet openings, for example, notches may be provided in the cell housing 4, wherein the notches burst when the pressure exceeds the threshold value. These notches are, for example, configured in such a manner that a crack which occurs after the bursting directs the hot gas in a specific direction and consequently allows it to flow away. The threshold value can, for example, be predetermined by structural configuration of the cell housing 4 and in particular the ventilation device 13.

In order to be able to produce a particularly effective and efficient temperature control, that is to say, cooling and/or heating of the storage cells 2 in a particularly cost-effective manner, the electrical energy store 1 has a cell holder 14 which is constructed separately from the storage cells 2 and also separately from the insulation device 10 and separately from the contacting device 9 and separately from the insulation device 11 and separately from the filling plate 12 and which is referred to as a holder and which in the embodiment illustrated in FIG. 1 has precisely two holder portions, that is to say, a first holder portion 15 and a second holder portion 16 which is constructed separately from the first holder portion 15 and which is in particular directly connected to the first holder portion 15. Both the holder portion 15 and the holder portion 16 are constructed integrally, consequently formed from a single piece and consequently constructed in a monobloc manner or formed by a monobloc. The respective holder portion 15, 16 is formed from a plastics material. For example, the respective holder portion 15, 16 is produced by means of injection-molding, in particular by means of plastics material injection-molding. In principle, it is conceivable for the holder portions 15 and 16 to be identical, that is to say, structurally identical, whereby the holder portions 15 and 16 can be produced by means of the same or identical tool, in particular by means of the identical or the same injection-molding tool. The cell holder 14 can thereby be produced in a particularly cost-effective manner. The holder portions 15 and 16 are components which are constructed separately from each other and which are connected to each other, in particular in a releasable manner, with or without destruction. In the completely produced state of the energy store 1, the holder portions 15 and 16 are locked to each other and consequently clip-fitted to each other so that the holder portions 15 and 16 are connected to each other in a positive-locking manner. The storage cells 2 are in particular directly supported on the cell holder 14 and retained on the cell holder 14, whereby relative movements between the storage cells 2 with respect to each other and relative movements between the respective storage cell 2 and the cell holder 14 are at least limited, preferably prevented. Furthermore, the storage cells 1 are retained by means of the cell holder 14 with a respective spacing from each other, and the storage cells 2 are retained relative to each other by means of the cell holder 14 in a pattern which can be seen, for example, in FIG. 5. For example, first ones of the storage cells 2 are arranged in a first cell row, whilst second ones of the storage cells 2 are arranged in a second cell row. This is intended in particular to be understood to mean that the first storage cells are arranged one after the other along a first straight line, whereby the first storage cells form the first cell row and the second storage cells are arranged one after the other along a second straight line, whereby the second storage cells form the second cell row. The straight lines extend parallel with each other so that the cell rows are arranged beside each other, in particular along a third straight line or in a sequential direction, wherein the third straight line or the sequential direction extends perpendicularly to the first straight line and perpendicularly to the second straight line. In particular, the storage cells 2 are constructed in a structurally identical or identical manner.

As can be seen particularly clearly from an overview of FIGS. 1 and 3, the cell holder has domes 17 and 18 which are constructed separately from the storage cells 2 and consequently separately from the cell housings 4 and separately from the line elements 7 and through which, as illustrated in FIG. 3 by the arrows 35, the preferably liquid temperature-control means can flow. Via the domes 17 and 18, the temperature-control means can be introduced into the line elements 7 and discharged from the line elements 7, that is to say, directed out of the line elements 7 or the channels 8. From FIG. 3 it can be seen particularly clearly that the first upper holder portion 15 has the domes 17, wherein the lower, second holder portion 16 has the domes 18. In this instance, the respective dome 17, 18 is sealed with respect to the respective line element 7, in particular in the respective channel 8, by means of a respective sealing element 19 which is constructed separately from the respective line element 7 and separately from the respective dome 17, 18 and which in the embodiment shown in the Figures is formed from a rubber and is in the form of a sealing ring, in particular an O-ring. Since at least or precisely two domes 17 and 18 are provided for each line element 7, at least or precisely two sealing elements 19 are provided for each line element 7, by means of which the respective two domes 17 and 18 which belong to the respective line element 7 are sealed with respect to the respective associated line element 7. In this instance, for example, the respective sealing element 19 is arranged in a respective corresponding indentation 20 of the respective cell holder 4, whereby relative movements between the respective sealing element 19 and the respective cell housing 4 and consequently relative movements between the respective sealing element 19 and the respective dome 17, 18 are least limited, in particular prevented. In this instance, as a result of at least one of the respective indentations 20 of the respective cell housing 4, respective structural elements, which are constructed separately from the respective cell housing 4 and which are arranged in the respective receiving space 5, of the respective storage cell 2 are fixed on the respective cell housing 4 of the respective storage cell 2 and to each other. A first of the respective structural elements may, for example, be a respective contact element. Alternatively or additionally, for example, a respective second one of the respective structural elements may be an electrical heating element by means of which, for example, the respective storage cell 2 can be electrically heated. In particular, for example, the electrical heating element may be a PTC element.

The domes 17 are supply domes which are inserted from a first side of the storage cells 2 into the line elements 7. In this instance, the end sides S1 are arranged at the first side or face the first side. Preferably, the domes 17 extend through the end sides S1. The domes 18 are discharge domes which are inserted into the line elements 7 from a second side which faces away from the first side and which is opposite the first side in the spacing direction. In this instance, the sides in the same manner as the end sides S1 and S2 are opposite each other in the respective longitudinal extent direction. The end sides S2 are arranged at the second side or face the second side. Via the supply domes, the temperature-control means can be introduced into the line elements 7 and consequently into the channels 8. Via the discharge domes, the temperature-control means can be discharged out of the line elements 7 and consequently out of the channels 8, that is to say, directed out. Since the supply domes are components of the holder portion 15 which is constructed in an integral manner, the supply domes are constructed integrally with each other, consequently formed from a single piece. In this instance, the holder portion 5 has a supply line element 21 which is common to the supply domes and which is constructed integrally with the supply domes and through which the temperature-control means can flow so that the supply domes and the supply line element 21 are formed from a single piece. Via the supply line element 21, the supply domes can be supplied with the temperature-control means. The configuration which is provided in the embodiment shown in the Figures that the domes 17 are the supply domes and the domes 18 are the discharge domes could of course also be the other way round so that, for example, the domes 17 could be the discharge domes and the domes 18 could be the supply domes.

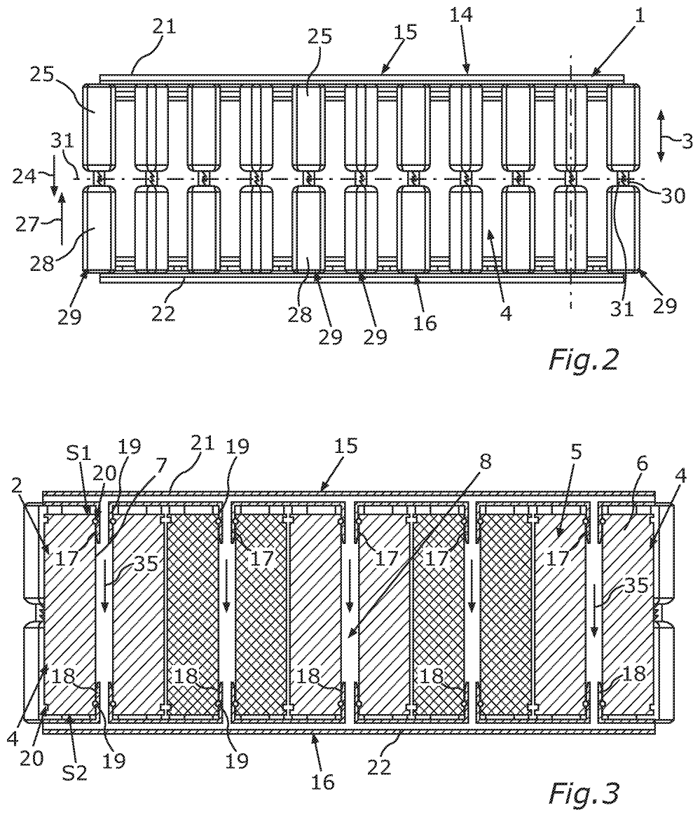

Since the supply domes are components of the second holder portion 16 which is constructed in an integral manner, the discharge domes are constructed integrally with each other, consequently formed from a single piece. In this instance, the second holder portion 16 has a discharge line element 22 which is common to the discharge domes and which is constructed integrally with the discharge domes and through which the temperature-control means can flow and in which the temperature-control means can be introduced from the discharge domes so that, via the discharge line elements 22, the temperature-control means can be discharged from the discharge domes. This means that the discharge domes and the discharge line element 22 are formed from a single piece. Furthermore, it can be seen that, while the holder portion 15 is arranged at the first side, the second holder portion 16 is arranged at the second side. It can be seen particularly clearly in FIG. 1 that the first holder portion 16 has a first covering element 23 from which in a first direction which faces from the first side and from the covering element 23 toward the second side and which is illustrated by an arrow 24 the supply domes and first column portions 25 of the first holder portion 15 protrude. The second holder portion 16 has a second covering element 26 which is arranged on the second side and from which in a second direction which faces from the second side and from the second covering element 26 to the first side and which is opposite the first direction and which is illustrated by an arrow 27, the discharge domes and second column portions 28 of the second holder portion 16 protrude. Consequently the domes 17, the supply line element 21, the covering element 23 and the column portions 25 are constructed integrally with each other, consequently formed from one piece and in this instance formed by the first holder portion 15 which is constructed in an integral manner and which is consequently formed from a single piece. Furthermore, the domes 18, the discharge line element 122, the covering element 26 and the column portions 28 are accordingly constructed integrally with each other, consequently formed from a single piece and in this instance formed by the second holder portion 16 which is constructed in an integral manner and consequently formed from a single piece. One of the column portions 25 and one of the column portions 28 form, as can be seen in FIG. 2, a respective column portion pair 29, the respective second column portion 28 of which adjoins in the first direction (arrow 24) the respective first column portion 25 of the respective column portion pair 29. The respective column portions 25 and 28 of the respective column portion pair 29 are connected to each other. In this instance, the column portions 25 and 28 of the respective column portion pair 29 are locked to each other. The storage cells 2 are in the first direction (arrow 24) at least indirectly, in particular directly, supported on the second covering element 26 and the storage cells 2 are in the second direction (arrow 27) at least indirectly, in particular directly supported on the first covering element 23.

The respective storage cell 2 is associated with respective ones of the column portion pairs 29. In this case, the respective column portion pairs 29 which are associated with the respective storage cell 2 are arranged successively and with spacing from each other, and preferably in a state distributed uniformly, in a circumferential direction, which extends around the longitudinal extent direction of the respective storage cell 2, of the respective storage cell 2 with which the respective column portion pairs 29 are associated so that the respective storage cell 2 is surrounded in a circumferential direction of the respective storage cell 2 by the column portion pairs 29 which belong to the respective storage cell 2.

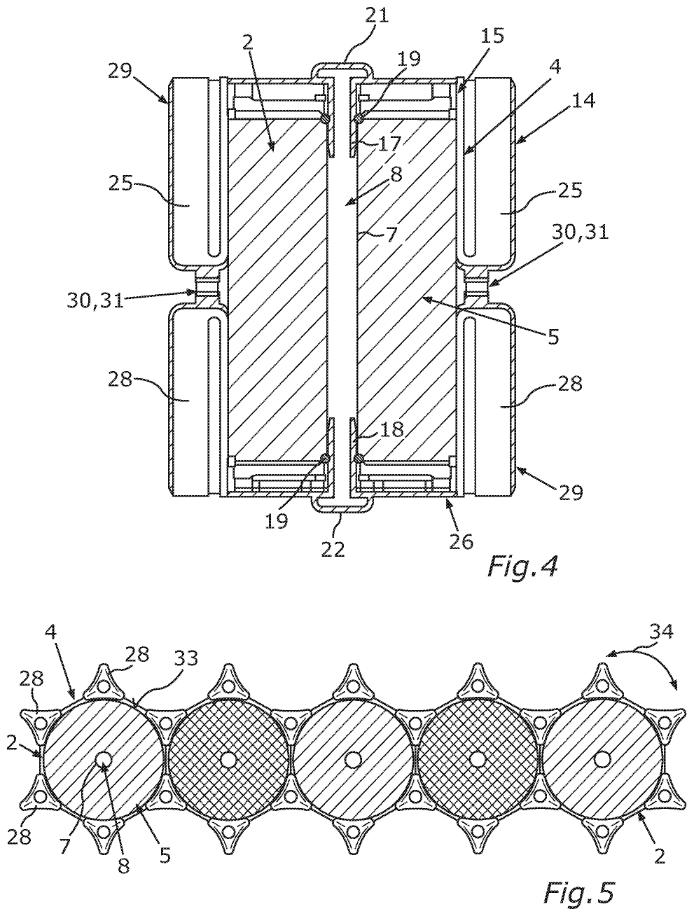

The respective column portion 25 has a respective connection element 39, and the respective column portion 28 has a respective connection element 31. The connection elements 30 and 31 of the column portions 25 and 28 of the respective column portion pair 29 are in this instance locked to each other, consequently connected to each other in a positive-locking manner, whereby the column portions 25 and 28 of the respective column portion pair 29 are locked to each other. It can be seen particularly clearly in FIG. 4 that the respective domes 17 and 18 are inserted into the respective channel 8 and consequently into the respective line element 7. Furthermore, it can be seen in FIG. 5 that, for example, the respective column portion 25, 28 is adapted to the outer circumferential shape of the respective cell housing 4 and in this instance is constructed, for example, in a concave manner so that the cell housing 4, in particular a respective outer circumferential covering face 33 of the respective cell housing 4, advantageously abuts in particular in a planar manner against the respective column portion 25, 28. In FIG. 5, the respective circumferential direction, which extends around the respective longitudinal extent direction of the respective storage cell 2, of the respective storage cell 2 is illustrated by means of a double-headed arrow 34. The supply line element 21 is, for example, open at one end, in particular at the first end thereof, and closed at the other end, in particular at the second end thereof, so that, for example, via the one end the temperature-control means can be introduced into the supply line element 21. Furthermore, the temperature-control means can thus be prevented from flowing out of the supply line element 21 in an undesirable manner at the other end. Consequently, there may be provision for the discharge line element 22 to be open at one end, in particular at the first end thereof, and closed at the other end, in particular at the second end. Consequently, for example, it is possible for the temperature-control means to be discharged at the one end or via the one end of the discharge line element 22 from the discharge line element 22, whilst at the other end or via the other end of the discharge line element 22 the temperature-control means can be prevented from flowing out of the discharge line element 22 in an undesirable manner. The supply line element 21 or the discharge line element 22 may, for example, in particular at the respective other end thereof be closed by means of a closure element, such as, for example, a plug. The closure element is, for example, sealed by means of a sealing element with respect to the supply line element 21 or with respect to the discharge line element 22.

As a result of the fact that the holder portions 15 and 16 form the domes 17 and 18, and as a result of the fact that the holder portions 15 and 16 are connected, in particular locked to each other by means of the column portions 25 and 28, it is possible to prevent the domes 17 and 18 from being pressed out of the line elements 7 by means of a corresponding pressure of the temperature-control means. An effective and efficient temperature control of the storage cells 2 can thereby be achieved in a particularly cost-effective manner. In particular, the number of components and consequently the costs of the electrical energy store 1 can be kept in a particularly low range. In particular, there is provision for the supply line element 21, in particular the channel thereof through which the temperature-control means can flow, in particular precisely at one of the ends thereof to be closed, in particular plugged, welded, preferably by means of laser welding, and/or shaping in order to produce a corresponding guide of the temperature-control means, in particular according to the arrows 35. Furthermore, for example, there is provision for the discharge line element 22, in particular the channel thereof through which the temperature-control means can flow, in particular precisely at one of the ends thereof, to be closed, in particular plugged, welded, preferably by means of laser welding, and/or shaping in order to produce a corresponding guide of the temperature-control means, in particular according to the arrows 35.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Electrical energy store

2 Storage cell

3 Double-headed arrow

4 Cell housing

5 Receiving space

6 Storage device

7 Line element

8 Channel

9 Contacting device

10 Insulation device

11 Insulation device

12 Filling plate

13 Ventilation device

14 Cell holder

15 First holder portion

16 Second holder portion

17 Dome

18 Dome

19 Sealing element

20 Indentation

21 Supply line element

22 Discharge line element

23 Covering element

24 Arrow

25 Column portion

26 Covering element

27 Arrow

28 Column portion

29 Column portion pair

30 Connection element

31 Connection element

33 Outer circumferential covering face

34 Double-headed arrow

35 Arrow

S1 First end side

S2 Second end side

What is claimed is:

1. An electrical energy store for storing electrical energy for a motor vehicle, comprising:
a plurality of storage cells which are configured to store the electrical energy and which each comprise:
a cell housing which delimits a receiving space; and
a line element through which a temperature-control liquid can flow and which extends through the receiving space,
wherein the plurality of storage cells are retained with a cell holder that is constructed separately from the plurality of storage cells and which at least limits relative movement between the plurality of storage cells, and which comprises domes through which the temperature-control liquid can flow and which are inserted into the line elements, and via which the temperature-control liquid can be introduced into the line elements and/or discharged from the line elements.

2. The electrical energy store according to claim 1, wherein
a respective dome of the domes is sealed with respect to a respective line element, in which the respective dome is inserted, by a sealing element which is constructed separately from the respective line element and separately from the respective dome.

3. The electrical energy store according to claim 2, wherein
at least first ones of the sealing elements are arranged in corresponding indentations of a respective cell housing.

4. The electrical energy store according to claim 3, wherein
at least a respective structural element, which is constructed separately from the respective cell housing and which is arranged in the respective receiving space, of the respective storage cell is fixed to the respective cell housing via a respective indentation of the respective cell housing.

5. The electrical energy store according to claim 4, wherein
the respective structural element comprises a respective contact element and/or a respective electrical heating element.

6. The electrical energy store according to claim 1, wherein:
first ones of the domes are supply domes which are inserted from a first side into the line element and via which the temperature-control liquid can be introduced into the line elements, and
second ones of the domes are discharge domes which are inserted from a second side opposite the first side into the line elements and via which the temperature-control liquid can be discharged from the line elements.

7. The electrical energy store according to claim 6, wherein
the supply domes are constructed integrally with each other.

8. The electrical energy store according to claim 7, comprising:
a supply line element which is common to the supply domes and which is constructed integrally with the supply domes and through which the temperature-control liquid can flow and via which the supply domes can be supplied with the temperature-control liquid.

9. The electrical energy store according to claim 6, wherein
the discharge domes are constructed integrally with each other.

10. The electrical energy store according to claim 9, comprising:
a discharge line element which is common to the supply domes and which is constructed integrally with the discharge domes and through which the temperature-control liquid can flow and into which the temperature-control liquid from the discharge domes can be introduced so that the temperature-control liquid can be discharged from the discharge domes via the discharge line element.

11. The electrical energy store according to claim 6, wherein:
the cell holder has a first holder portion which has the supply domes and which is arranged on the first side,
the cell holder has a second holder portion (16) which has the supply domes and which is arranged on the second side, and
the first holder portion and the second holder portion are constructed separately from each other and connected to each other.

12. The electrical energy store according to claim 11, wherein:
the first holder portion has a first covering element which is arranged on the first side and from which in a first direction, which faces from the first side and from the first covering element to the second side, the supply domes and first column portions of the first holder portion protrude,
the second holder portion has a second covering element which is arranged on the second side and from which in a second direction, which faces from the second side and from the second covering element to the first side and which is counter to the first direction, the discharge domes and second column portions of the second holder portion protrude,
a respective one of the first column portions and a respective one of the second column portions form a respective column portion pair, the respective second column portion of which adjoins in the first direction the respective first column portion of the respective column portion pair, and
the respective column portions of the respective column portion pair are connected to each other.

13. The electrical energy store according to claim 12,
wherein the respective column portions of the respective column portion pair are locked to each other.

14. The electrical energy store according to claim 11,
wherein the respective holder portion is constructed in an integral manner.

15. A motor vehicle having at least one electrical energy store according to claim 1.
